(19) United States
(12) Patent Application Publication
(10) Pub. No.: US 2004/0090224 A1
(43) Pub. Date: May 13, 2004

(54) Ignition system tachometer driver

(75) Inventors: Stephen C. Masters, El Paso, TX (US); Douglas B. Waits, El Paso, TX (US)

Correspondence Address: FITCH EVEN TABIN AND FLANNERY, 120 SOUTH LA SALLE STREET, SUITE 1600, CHICAGO, IL, 60603-3406, US

(73) Assignee: Autotronic Controls Corporation

(21) Appl. No.: 10/293,762

(22) Filed: Nov. 13, 2002

(51) Int. Cl. G01P 3/42

(52) U.S. Cl. 324/160; 324/392

(57) ABSTRACT

A digital ignition system tachometer driver connected to an ignition coil of the ignition of an automobile for converting the ignition coil signal from one or more ignition coils to a single tachometer output signal. The digital ignition system tachometer driver includes a current mirror for mirroring the coil current, a voltage comparator for comparing the mirrored current to a reference voltage, and a mode detector for determining whether the coils are operating in a multispark mode. A reverse-polarity and over-voltage protection circuit is provided to protect the current mirror. An input current and voltage limiting circuit is provided for protecting the tachometer driver circuit.

### FIELD OF THE INVENTION

The present invention relates generally to ignition systems for internal combustion engines and, more particularly, to a system for generating tachometer output signals from ignition coils.

### BACKGROUND OF THE INVENTION

A tachometer is often used for measuring velocity and operates much like a generator. For example, when a motor drives the tachometer, the tachometer generates an output voltage. The produced output voltage is proportional to the velocity of the motor. The velocity signal may then be fed to a rate indicator to display the velocity to the operator, or it can be used to close a velocity loop. More particularly, the tachometer drive circuit receives pulses from an ignition coil in the ignition system of the motor and then displays these pulses as engine speed.

One method by which tachometer or ignition trigger signals may be generated is by inductively coupling a magnetic sensing pickup on the ignition coil high voltage spark output wire. This method has been used in ignition timing lights for decades. U.S. Pat. No. 6,058,902 to Jacobs discloses a circuit in which the original vehicle ignition coil high-tension lead is connected to a sense resistor to sense the ignition trigger for an after-market ignition trigger input. Other methods include tapping into the ignition coil negative lead to monitor the coil kickback signal when the coil is fired on an inductive ignition coil to generate the tachometer signal. A disadvantage of these methods is their inability to produce a clean tachometer output signal using simple, reliable, low cost circuitry.

Further, a particularly significant limitation of the prior art methods described above is their inability to extract a clean accurate tachometer signal from an ignition coil that is in multi-spark operation. As such, regardless of the method used to detect coil operation, the multi-spark signal must be managed to provide a proper tachometer output signal. Another limitation is that in an engine having multiple coils, each of the coils must be connected to the tachometer signal generating circuit, resulting in requiring up to eight inputs on a coil per plug ignition system. Furthermore, extra wires are often needed for providing battery voltage to the signal generating circuit. In addition, many of the existing methods do not have the capability to be used universally in all existing single and multiple ignition coil equipped vehicles.

### SUMMARY OF THE INVENTION

In order to address the need for a clean and accurate tachometer signal to be extracted from an ignition coil in multi-spark operation and others, there is provided a digital ignition system tachometer (DIS-tach) driver that is used to convert the ignition coil signal from one or more ignition coils to a single tachometer output signal that is capable of driving tachometers, shift lights, RPM activated switches and similar devices that require an engine RPM signal.

Numerous advantages are realized with the DIS-tach driver described herein. For example, the DIS-tach driver is connected with only a single splice in the vehicle coil and harness to draw power and detect coil current for generation of the tachometer output signal. This results in an inexpensive and simple fitting of the DIS-tach driver to the engine.

An additional advantage is the universality of the device. In particular, the DIS-tach driver may be connected to most vehicles having one or more ignition coils. Particularly significant is that the DIS-tach drive is compatible with vehicles that provide multi-spark operation of the ignition coils without requiring the user to program the cylinder count.

### BRIEF DESCRIPTION OF THE DRAWINGS

FIGS. 1A and 1B are schematic diagrams of the digital ignition system tachometer driver;

FIG. 2 is a timing diagram of a three-spark multispark ignition coil system of the digital ignition system tachometer driver of FIG. 1;

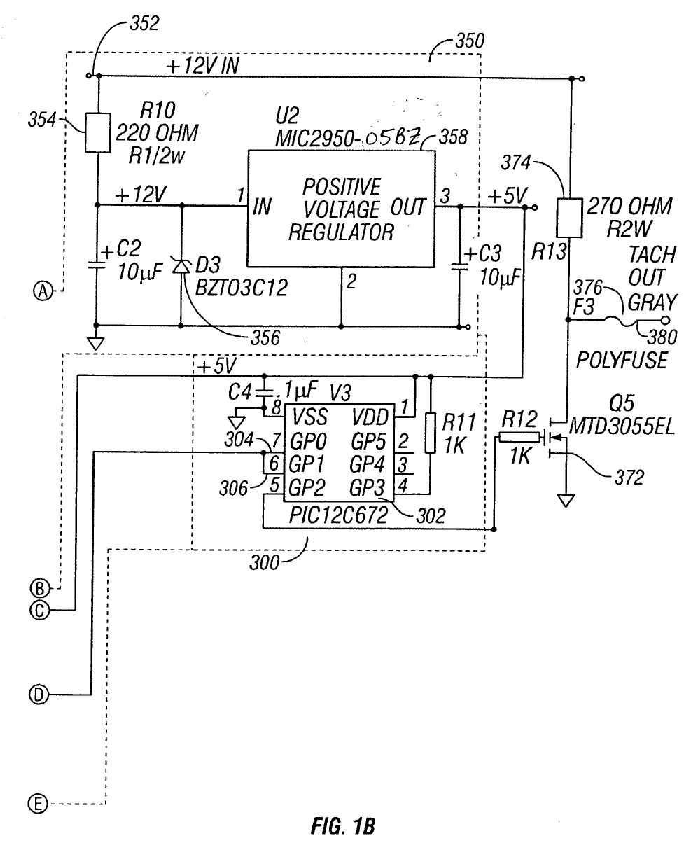

FIG. 3 is a timing diagram of a two-spark multispark ignition coil system of the digital ignition system tachometer driver of FIG. 1; and

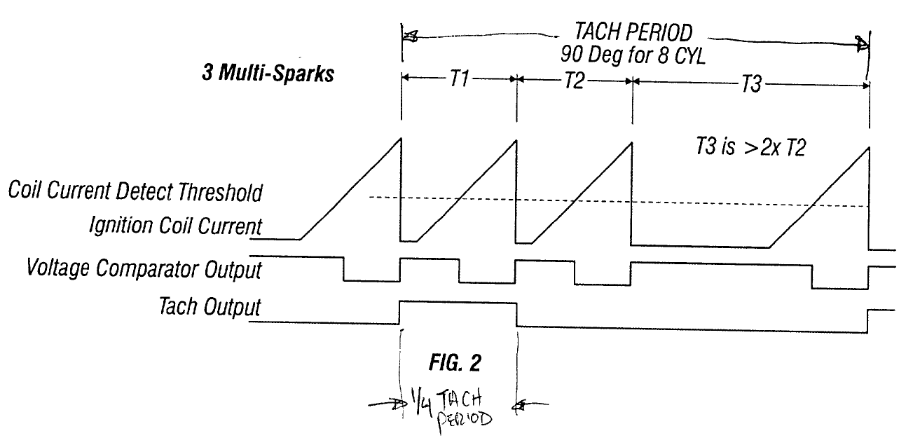

FIG. 4 is a timing diagram of a single-spark ignition coil system of the digital ignition system tachometer driver of FIG. 1.

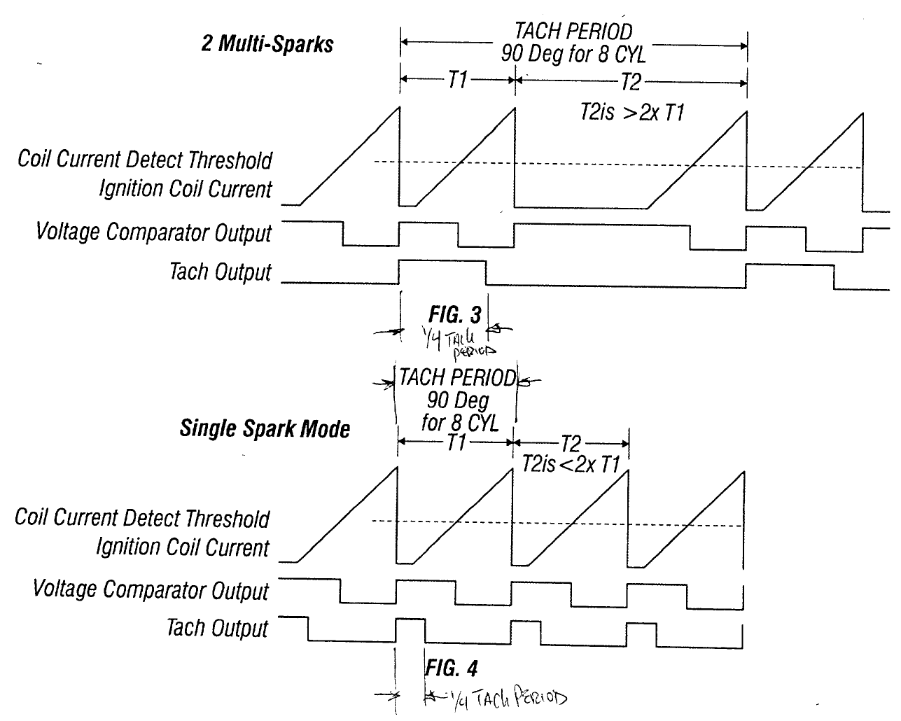

### DETAILED DESCRIPTION

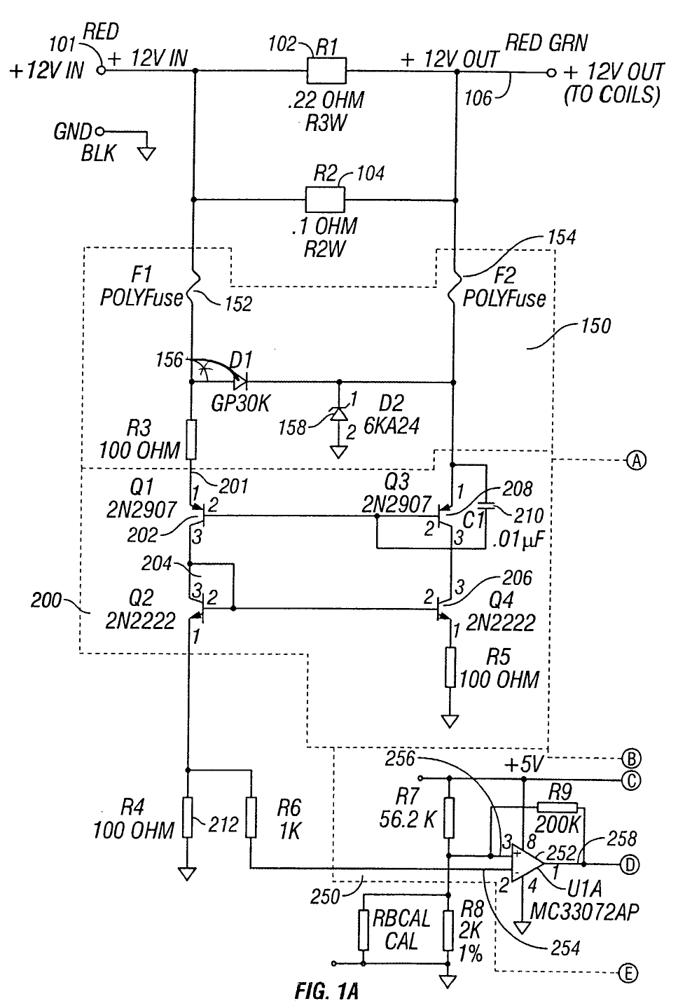

In FIG. 1, a digital ignition system tachometer driver in accordance with the present invention is illustrated. The DIS-tach driver 100 is an electronic device that is connected to the ignition coil or coils of the ignition of an automobile. The DIS-tach driver 100 includes a current mirror 200 for mirroring the coil current, a voltage comparator 250 for comparing the mirrored current to a reference voltage, and a mode detector 300 for determining whether the coils are operating in a multispark mode. Advantageously, a reverse-polarity and over-voltage protection circuit 150 is provided to protect the current mirror. Similarly, an input current and voltage limiting circuit 350 is provided for protecting the tachometer driver circuit.

The DIS-tach driver 100 output line is connected to the ignition coil, coil pack, or coils (not shown) using a simple shunt resistor wired in series with the coils. The shunt resistor may be of any low value to limit the maximum voltage drop between an ignition switch and the ignition coil input. By way of example and not limitation, for example, the value of the sense resistor is shown to be 0.06875 ohms, consisting of one 0.1 ohm two-watt resistor 104 connected in parallel to one 0.22 ohm three-watt resistor 102. The input to the DIS-tach driver is from a positive 12 volt source, such as the automobile battery. It is to be understood that the actual hook-up will vary between makes and models of automobiles and that the above description is by way of example and not limitation.

The coil current is mirrored by a four-transistor current mirror 200 that is used to generate a ground referenced voltage signal proportional to the ignition coil. The current mirror 200 in an exemplary embodiment includes two PNP transistors 202, 208, two NPN transistors 204, 206 and an AC bypass capacitor 210. The PNP transistors, which may be 2N2907 silicon (bipolar) transistor amplifiers, are available from Fairchild Semiconductor and the NPN transistors, which may be 2N2222 silicon (bipolar) transistor amplifiers, are available from Motorola. Note that other similar transistors may be used as well.

A particular advantage of the AC bypass capacitor 210, which may be a 0.01 micro-farad capacitor connected from the collector to emitter of the PNP transistor 208, is that AC current is bypassed around the capacitor 206. This ensures that the current mirror 100 will not latch-up due to any slight imbalance that may result in mismatched gains in the four transistor mirror network. In particular, the capacitor 210 prevents even small voltage errors from causing the mirror 200 to fail to track the shunt resistor when voltage is ramping. It is to be noted that other current sensing means may also be used also sense coil currents. Such devices include, but are not limited to, current transformers, optical isolators, current sensing integrated circuits, hall-effects, magneto-restrictive devices and others.

The current mirror proportioned signal from the current mirror 200 is compared to a voltage reference, representative of about 2.5 amperes by an operational amplifier (op-amp) 252 configured as a voltage comparator 250. The op-amp 252 may be a type such as the MC33072AP from ON-Semiconductor, which is rated for −40 to +85 degree Celsius operation. Advantageously, using the op-amp 252, instead of a discrete voltage comparator, results in a fast slew rate of about two volts/microsecond. This results in quieter operation than most available voltage comparators. It is to be understood that a voltage comparator or other voltage comparison device may be used instead of the exemplary op-amp 252.

The output of the comparator 250 goes low when the sensed ignition coil current rises above the 2.5 amp reference. The current mirror signal generates a voltage across a 100-ohm resistor 212 and is input at the inverting input pin 254 of the op-amp 252. A current reference voltage of about 0.172 volts is input at the non-inverting input 256 of the op-amp 252.

The output 258 of the op-amp 252 at pin 1 is then fed to the mode detector 300. In particular, the output signal 258 is connected to the input pins 304, 306 of a microcontroller 302, which may be, for example, an 8-bit microcontroller in an 8-pin package such as the PIC12C672 from Microchip Technology Inc. The microcontroller 302 receives the signal from the comparator 252 when the ignition coil current is greater than 2.5 amps and interrupts on the edges of the signal 258. The signal 258 is then processed by the microcontroller 302 to measure the time period of the incoming signal. This signal is discriminated to be a multi-spark or normal signal by the microcontroller 302. This is accomplished by analyzing the input signal time period in multiple increments.

The following exemplary method of operation uses three sequential time periods but could use any number of three or more periods. The choice of three time-period measurements for the DIS-tach device 100 is based on the maximum multi-sparks available on a Ford Motor Company (Ford) DIS equipped vehicle. The Ford DIS ignition coil outputs from one to three multi-sparks, three being the most at idle speed. Therefore, measuring these three sparks provides a spark period of two small periods to one larger period. The larger period must be at least two times greater than the small periods to be discriminated as being a multi-spark period. After the microcontroller 302 has measured eight incoming tachometer sensed signals, the time period is calculated and the output signal is output every engine cylinder firing. When the input signal is normal, e.g. not multi-sparking, the input tachometer signal is evenly spaced and the microcontroller measures each input period with less than a 2:1 change; the microcontroller outputs a tachometer signal for each input signal.

The tachometer output signal is synchronous with the falling edge of the last wide tachometer input period; aligned with the normal first spark of each cylinder firing. The tachometer input period is measured from fall to fall of the coil signal, which is the time when each coil is providing spark to the spark plugs. If the measured tachometer input period is less than a 2:1 range then the microcontroller outputs a tachometer signal for every input signal because the coil is not in multispark mode of operation. The output tachometer signal duration is limited to 2 milliseconds or 25% of the tachometer period. This duration limit allows all tachometers, shift lights, and other RPM input devices to function without any cylinder information programming of the DIS-tach driver.

The microcontroller does not calculate RPM or degrees for any of the measurements, only time is measured for input period and output duration. This allows the microcontroller to be run with an internal 4 MHZ clock and does not require any cylinder programming of the microcontroller for use on engines with any number of cylinders. The only exception of the input/cylinder count is that the cylinders must have a symmetrical firing pattern. This means that the use of the DIS tachometer Driver when used on a V-10 engine, like the Dodge Viper, will have a odd firing pattern of 90/54 degrees and requires a modified microcontroller to accept the asymmetrical input signal and convert it to a symmetrical output and an engine repetition rate of 90 degrees to use a conventional after market tachometer or other RPM input device for use on 8 cylinder engines.

The microcontroller 302 can be programmed with the required algorithm to support this odd-fire application as well as other odd-fire engines like the Buick V-6 odd fire engine. The microcontroller 302 drives a power MOSFET transistor 372, such as a Motorola MTD3055EL, which is connected to a 270-ohm 2-watt pull up resistor 374, and to the output polyfuse 376. The output polyfuse 376 provides a self-resetting function in the event of a short to positive battery voltage to protect the power MOSFET 372.

The DIS-tach driver 100 also provides for reverse polarity and over-voltage protection. As described above, the internal current mirror 200 uses four signal transistors 202, 204, 206, 208. The transistors 202, 204, 206, 208 are subject to possible damage if subjected to high voltages caused by a “load dump” or other over-voltage surges.

To reduce the chance of such damage, the voltage protection circuit 150 includes a pair of polyfuses 152, 154, a diode 156, and a transient surge suppressor diode 158. The clamping action of the suppressor diode 158 limits the maximum collector voltage of the current mirror input 201 to about 33 volts, which is below the breakdown rating of the current mirror transistors 202, 204, 206, 208. As the suppressor diode 158 clamps the input voltage at the cathode of diodes 156, 158, the balance of the over-voltage is developed across the polyfuses 152, 154. This large clamp current through the polyfuses 152, 154, through the diodes 156, 158 to ground causes rapid heating of the polyfuses 152, 154. As a result, the polyfuses 152, 154 become open-circuited, which then drops the current to a few milliamps until the over-voltage ceases. Once the over-voltage has ceased, the polyfuses 152, 154 cool and revert to a low impedance state, which results in reconnecting the input current signal to the mirror, thereby allowing continued operation of the DIS-tach driver 100.

There is also provided an input current and voltage limiting circuit 350 to protect the DIS-tach driver 100. The limiting circuit 350 is connected on the positive input 352 to the DIS-tach driver 100. The limiting circuit 350 includes a current limiting resistor 354, a zener diode 356 and a low-voltage dropout regulator 358. By way of example, the current limiting resistor is a 220 ohm ½ watt resistor, the diode 356 is a 12-volt, 3-watt zener, such as the BZT03C from Philips Semiconductor, and the low-voltage dropout regulator 358 is a MIC2950-05BZ from Micrel Semiconductor.

The limiting circuit 350 provides operating voltage to the op-amp 252 and microcontroller 302 from the ignition switched+voltage input 101 and is clamped to fewer than 12.5 volts by the diode 356 and regulated to precisely 5 volts by the low voltage dropout regulator 358. Advantageously, the DIS-tach driver 100 operates with an output down to typically about 6.5 volts battery input.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. An electronic driver for producing a tachometer output, comprising:
an input for connecting the electronic driver to an ignition coil supply for drawing power and detecting coil currents;
a controller for receiving the generated reference signal and processing the signal to output a single tachometer signal representative of the number of ignition coils connected to the electrical input and the mode in which the coils are being operated.

2. The electronic driver of claim 1, wherein the electronic driver is connected to the coil supply using a single wire splice.

3. The electronic driver of claim 1, wherein the coil supply comprises a single ignition coil.

4. The electronic driver of claim 1, wherein the coil supply comprises multiple ignition coils.

5. The electronic driver of claim 1, wherein the coil supply operates in a multiple spark mode of operation.

6. The electronic driver of claim 5, wherein the coil supply provides a non-symmetrical signal to the electronic driver.

7. The electronic driver of claim 1, further comprising a controller for distinguishing between multiple spark and single spark modes of coil supply operation.

8. The electronic driver of claim 1, further comprising a current mirror for generating a reference signal proportional to the coil supply current; and

9. The electronic driver of claim 8, wherein the current mirror includes an AC bypass for preventing errors in the current mirror caused by a voltage imbalance in the current mirror.

10. The electronic driver of claim 1, further comprising a controller for limiting tachometer signal duration to enable RPM input devices to operate without cylinder information.

11. The electronic driver of claim 1, further comprising a controller for generating tachometer output without calculating cylinder RPM and degree.

12. The electronic driver of claim 11, wherein the controller measures input period time and output duration time of the tachometer signal.

13. The electronic driver of claim 1, further comprising a self-resetting circuit in response to a short circuit of the electronic driver.

14. A method for producing a tachometer output signal from one or more ignition coils, the method comprising the steps of:
connecting an electronic driver to an ignition coil supply for drawing power and detecting coil currents; and
processing the generated reference signal to output a single tachometer signal representative of the number of ignition coils connected to the electrical input and the mode in which the coils are being operated.

15. The method of claim 13, further comprising the step of mirroring the coil current for generating a reference signal proportional to the coil supply current.

16. The method of claim 13, wherein the connecting step comprises the step of splicing the electronic driver to the ignition coils using a single splice.

17. The method of claim 13, further comprising the step of limiting voltage to the electronic driver to prevent voltage surges.

18. The method of claim 13, further comprising the step of bypassing AC current through the electronic driver to prevent the mirroring step from failing.

19. The method of claim 13, further comprising the step of determining the operating mode of the ignition coils.

20. The method of claim 18, wherein the operating mode is a multi-spark mode of operation.

21. The method of claim 18, wherein the operating mode is a single-spark mode of operation.

22. The method of claim 13, further comprising the step of limiting the duration of the tachometer signal output for enabling RPM input devices to operate without cylinder information being programmed into the electronic device.

23. The method of claim 13, further comprising the step of generating tachometer output without measuring the engine RPM or cylinder degrees.

24. The method of claim 13, further comprising the step of self-resetting the electronic device in response to the electronic device experiencing a short circuit.
